(19) United States
(12) Patent Application Publication
(10) Pub. No.: US 2002/0095324 A1
(43) Pub. Date: Jul. 18, 2002

(54) Working scheme reviewing/managing unit and system

(75) Inventors: Tamio Kawai, Shizuoka (JP); Hirofumi Otani, Shizuoka (JP); Makoto Masuda, Shizuoka (JP); Masaaki Nakano, Shizuoka (JP)

Correspondence Address: ARMSTRONG,WESTERMAN & HATTORI, LLP, 1725 K STREET, NW., SUITE 1000, WASHINGTON, DC, 20006, US

(73) Assignee: Yazaki Corporation, Tokyo (JP)

(21) Appl. No.: 10/000,035

(22) Filed: Dec. 4, 2001

(30) Foreign Application Priority Data
Jan. 12, 2001 (JP) 2001-004964

(51) Int. Cl. G06F 17/60

(52) U.S. Cl. 705/8

(57) ABSTRACT

A working scheme reviewing and managing unit can display problems interfering with a working scheme to a plurality of staffs to realize the working scheme. The system includes: an itemized schedule storage means for storing schedules each associated with each of a plurality of work items to realize the working scheme; an individual schedule storage means for storing an individual schedule associated with each of the staffs in connection with the itemized schedules; an executed work report storage means for storing executed work reports each in connection with each of the individual schedules; a progress chart generating means for displaying a progress chart of the working scheme based on the itemized schedules and the executed work reports; an output means for outputting the progress chart generated by the progress chart generating means to display the progress chart according to a confirmation instruction for confirming a progress state of the working scheme; and a modification means for modifying at least one of the itemized schedules and the individual schedules according to a modification instruction based on the displayed progress chart. A working scheme reviewing and managing system has the reviewing and managing unit. The system also has a display unit that can be seen simultaneously by all the staffs so that the staffs can review the working scheme based on information indicated on the display unit. The indicated information is based on an output from the output means of the reviewing and managing unit.

### BACKGROUND OF THE INVENTION

1. Field of the Invention

The present invention relates to a working scheme reviewing/managing unit and a system including the unit. More particularly, the system can display the working scheme together with interfering problems thereof for a plurality of the staffs so that the staffs can review and manage the working scheme for realization of the scheme.

2. Related Art

An engineering section managed in use of such working schemes generally has experienced a vicious cycle of problems such as an insufficient study due to a chronic man-hour shortage, an improvement time-delay of fundamental technologies, a lack of accumulation/transmit of expertise, repetition of the same kinds of failures, a quality degradation of products, and an inefficient development work without a well managed work execution. To solve the problems, there has been proposed a Knowledge Intensive Staff Innovation Plan (called as KI plan hereinafter).

The KI plan deals with technical problems, management affairs, invigoration of workers, etc. for a development object not only by a person in charge but also by all staffs including a general manager, a section manager, and a group leader. The KI plan makes a development plan clearly recognizable for all the staffs with no ambiguity to eliminate such a vicious cycle as mentioned above. More specifically, according to a pre-determined master working schedule, a yearly schedule (long-term timetable) is prepared. Then, monthly schedules (medium-term timetable) and weekly schedules (short-term timetable) are formulated, for example, by means of technique analysis and strategy planing to regularly make a progress management of the working scheme. Various kinds of schedule charts are respectively drawn up on a large paper as a time table. For example, short-term timetables are drawn on a large paper to show detailed work items, planed man-hours, actual man-hours, etc. Tag pieces describing the man-hours are placed on the large paper. Based on regular confirmation and review of the work items, the medium-term timetables and the short-term timetables will be sequentially modified together with any addition thereof.

The KI plan positively utilizes an OJT (training on job) method and communication meetings of all the staffs to solve manifested problems for a person in charge. For example, the staffs gathers in a meeting room for averaging volumes of technical objects and necessary works to each staff, thereby making full use of management capacity of the staffs. For a simultaneous review of such work schedules by the staffs, it has been believed to be best to use the large papers and tag pieces as mentioned above.

However, the KI plan utilizing the large papers and tag pieces is not adequate for transfer and renewal of primary schedule charts. Furthermore, the KI plan is disadvantageous for referring other schedule charts in addition to the review of a primary schedule chart. Particularly, the KI plan is disadvantageous when the medium-term timetables are developed into individual weekly schedules to increase the large papers in number to indicate a larger volume of information.

In view of the aforementioned disadvantages, an object of the present invention is to provide a working scheme reviewing and managing unit and a system thereof. The system enables a sure execution of a working scheme, since the scheme can be reviewed by a plurality of staffs related to the scheme.

### SUMMARY OF THE INVENTION

For achieving the object, a basic aspect of the present invention is a working scheme reviewing and managing unit that can display problems interfering with a working scheme to a plurality of staffs to realize the working scheme, the working scheme drawn up by the staffs. The unit includes:

an itemized schedule storage means for storing schedules each associated with each of a plurality of work items to realize the working scheme,

an individual schedule storage means for storing an individual schedule associated with each of the staffs in connection with the itemized schedules,

an executed work report storage means for storing executed work reports each in connection with each of the individual schedules,

a progress chart generating means for displaying a progress chart of the working scheme based on the itemized schedules and the executed work reports,

an output means for outputting the progress chart generated by the progress chart generating means to display the progress chart according to a confirmation instruction for confirming a progress state of the working scheme, and

a modification means for modifying at least one of the itemized schedules and the individual schedules according to a modification instruction based on the displayed progress chart.

Thus, according to the confirmation instruction, the output means outputs the progress chart generated by the progress chart generating means. Then, the modification instruction is input based on the progress chart, so that the modification means modifies at least one of the itemized schedule and the individual schedule according to the modification instruction. Since the progress chart is drawn up based on the itemized schedule and the executed work report, the progress chart shows progress states of the work items relative to the working scheme. Thus, the staffs can recognize a progress state of the working scheme based on the progress chart and can know problems interfering with the working scheme. This allows the staffs to review the working scheme with ease. With referring to the progress chart, all the staffs can know problems of each staff in respect of the working scheme, so that the problems can be analyzed to be solved by all the staff. With the solutions of the problems, the modification instruction is input to quickly modify the work items and the individual schedules. Thus, the present invention can eliminate the disadvantages of the KI plan which is not adequate for transfer and renewal of primary schedule charts and for review of the primary schedule charts and other associated schedule charts. Hence, based on visibly developed charts and problems, the staffs can review and modify the working scheme to review and manage the working scheme by all the staffs, accordingly realizing the working scheme well drawn up by all the staffs.

According to a further feature of the invention, the unit further includes individual progress chart generating means for generating an individual progress chart based on the individual schedules and the executed work reports according to an individual confirmation instruction for confirming an individual progress state of the work items, and the output means outputs the individual progress chart to display the individual progress chart.

Thus, based on the individual confirmation instruction, the individual progress chart generating means provides the individual progress chart according to the individual schedule and the executed work report. The individual progress chart is output by the output means. Since the individual progress chart is generated according to the individual schedule and the executed work report, the individual progress chart indicates the progress state of each work item. This can manage the individual progress state of the individual progress chart associated with each staff. Furthermore, since the progress chart includes the individual progress charts, the progress states of the work items can be confirmed with referencing the progress states of the individual progress charts. Thus, the progress state directly associated with each staff is reviewed by all the staffs. This allows a quick solution of a problem involved by each staff since the problem can be easily recognized by all the staffs to analyze it better.

According to a further feature of the invention, the unit further includes a report storage means for storing a report in connection with one of the individual schedules which can not be executed as planed so as to provide the report to the staffs with regard to reasons and problems of the individual schedule, and the individual progress chart generating means generates the individual progress chart as a chart including a display area for displaying the report associated with the individual schedule.

Thus, the individual progress chart is provided by the individual progress chart generating means in connection with the report. Thereby, the individual progress chart can include the report, and the report can show problems and reasons thereof associated with each staff to all the staffs. This enables all the staffs to recognize the problems and reasons thereof associated with each staff, allowing a quick solution of the problems.

According to a further feature of the invention, the individual schedule includes an accidental task data associated with a task not preliminarily included in the work schedule, and the unit further comprises a re-scheduling means that modifies the individual schedule according to the accidental task data, wherein the individual progress chart generating means generates the individual progress chart as a chart having an accidental task display area for displaying the accidental task data of the individual schedule.

Thus, the individual progress chart generating means provides the individual progress chart as a chart including the accidental task display area. Since the individual progress chart indicates the accidental task, all the staffs can carry out the progress management and the schedule adjustment of the working scheme with reference to the accidental task. Accordingly, the review and modification of the working scheme can be done by the staffs with reference to the accidental task.

According to a further feature of the invention, a working scheme reviewing and managing system having the reviewing and managing unit includes a display unit that can be seen simultaneously by all the staffs so that the staffs can review the working scheme based on information indicated on the display unit, wherein the indicated information is based on an output from the output means of the reviewing and managing unit.

Thus, the display unit can be seen simultaneously by a plurality of the staffs. The display indicates the progress chart including the individual progress charts delivered from the working scheme reviewing and managing unit. With referring to the progress chart and the individual progress charts, a plurality of the staffs can recognize and analyze the working scheme and the problems interfering with the schedule. Thus, all the staffs can recognize and analyze the working scheme and the problems interfering with the schedule based on the indication of the display unit. This allows realization of the working scheme drawn up and managed by the plurality of staffs.

According to a further feature of the invention, a working scheme reviewing and managing system has the reviewing and managing unit. The system includes a plurality of intelligent terminal units each provided for each of the staffs, the intelligent terminal units connected to the reviewing and managing unit through a network, wherein each of the intelligent terminal units can display information based on an output from the output means of the reviewing and managing unit.

Thus, the intelligent terminal units receive information output from reviewing and managing unit through the network. The progress chart and the individual progress charts are indicated on a display of each intelligent terminal unit for each staff. Even when the staffs are at different places, the working scheme and the problems interfering with the scheme can be recognized and analyzed with referring to the progress charts and the individual progress charts by all the staffs. This allows realization of the working scheme drawn up and managed by the plurality of staffs.

### BRIEF DESCRIPTION OF THE DRAWINGS

FIG. 1 is a block diagram showing a basic configuration of a working scheme reviewing and managing unit according to the present invention;

FIG. 2 is an illustration showing a general configuration of a working scheme reviewing and managing system according to the present invention

FIG. 3 is a block diagram showing a general configuration of the working scheme reviewing and managing system unit of FIG. 2;

FIG. 4 is an illustration showing a file configuration associated with the working scheme reviewing and managing unit according to the present invention;

FIG. 5 is an illustration showing a data configuration of files of FIG. 4;

FIG. 6 is an illustration showing a data configuration of an individual schedule of FIG. 5;

FIG. 7 is a flowchart partially showing a general process executed by a CPU of FIG. 3;

FIG. 8 is another flowchart partially showing the general process executed by the CPU of FIG. 3;

FIG. 9 is an illustration showing an example of a selected image;

FIG. 10 is an illustration showing an example of a progress chart; and

FIG. 11 is an illustration showing an example of an individual progress chart.

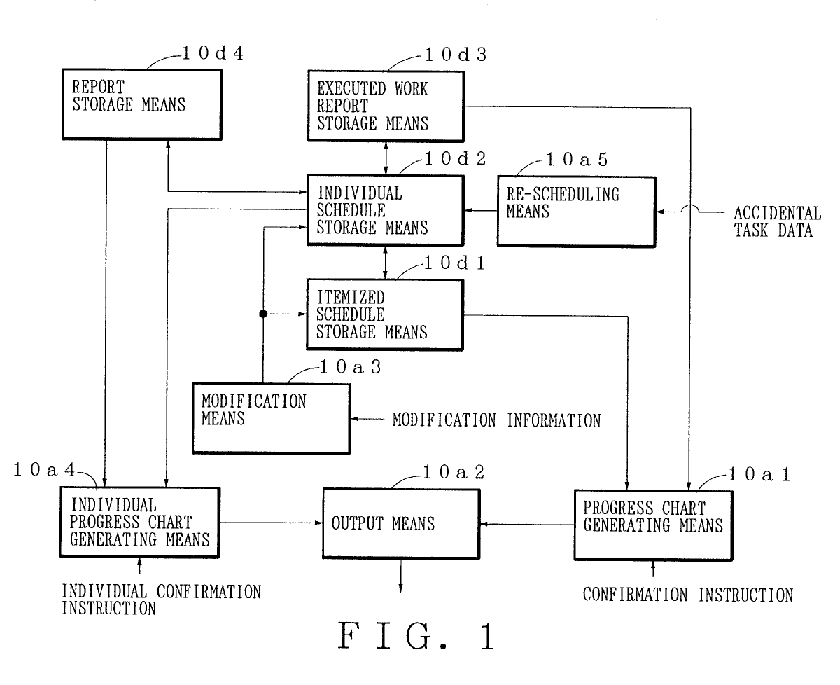

### DETAILED DESCRIPTION OF THE PREFERRED EMBODIMENT

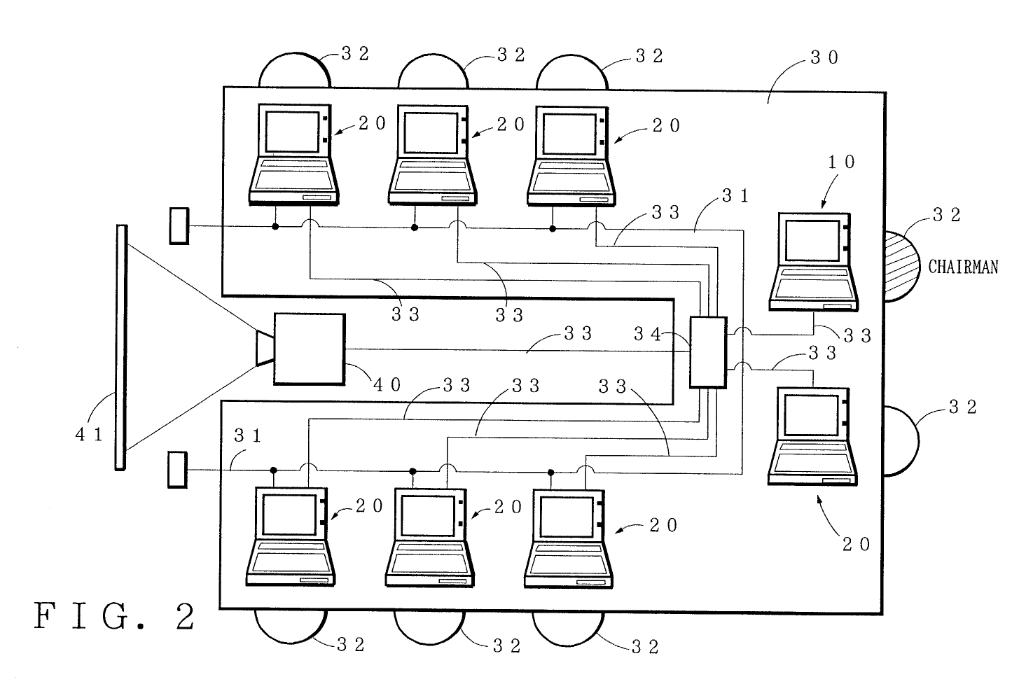

Referring to FIGS. 2 toll, embodiments of a working scheme reviewing and managing unit and a system thereof utilizing a meeting with multi-media will be discussed hereinafter. The working scheme reviewing/managing system, as illustrated in FIG. 2, is provided so that a plurality of staffs can participate to realize a working scheme related to a technical development, a sale promotion of a new product, an efficient productivity, a decrease of defects, a development cost reduction, a patent application promotion, or an extra hour reduction. The system includes a working scheme reviewing/managing unit 10 and a plurality of intelligent terminal units 20. Each terminal unit 20 is provided for each staff and communicates with the reviewing/managing unit 10 through a network to display the working scheme and problems interfering with the schedule for the staffs.

In the embodiment, it is intended that the staffs gather in a meeting room to analyze the working scheme and to manage the progress of the scheme. Therefore, the intelligent terminal unit 20 and the reviewing/managing unit 10 are respectively a portable notebook-sized personal computer.

The system includes a table 30 arranging the meeting staffs in a U-shape, a projector (display unit) 40 providing an image simultaneously visible for all the staffs, and a screen 41 displaying the image output by the projector 40.

Around the table 30, cables 31 are arranged to compose a network such as LAN (local area network) or WAN (wide area network) for connecting the reviewing/managing unit 10 to the intelligent terminal units 20. Near each seat 32 for each staff, there is provided a connection terminal (not shown) to connect the reviewing/managing unit 10 or the intelligent terminal unit 20 to the cables 31.

Near the table 30, there is provided a switching unit 34 selectively outputting image signals, which are received from the reviewing/managing unit 10 and the intelligent terminal units 20 through the cables 33, to the projector 40. In the embodiment, the switching unit 34 is located near a seat 32 of a chairman. Thereby, the chairman can selectively output any of the image signals to the projector 40 so that the screen 41 can display the selected image of the unit 10 and the intelligent terminal units 20.

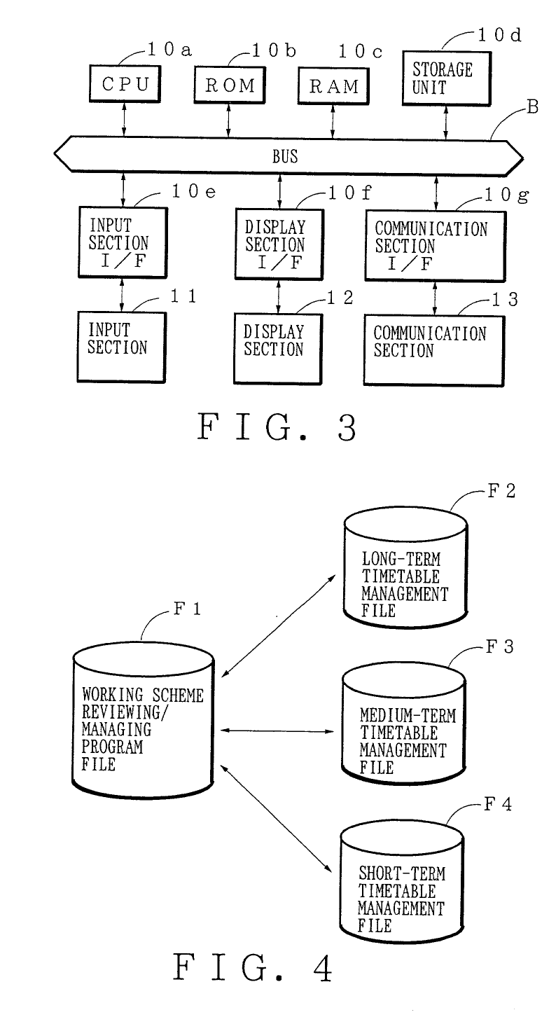

As illustrated in FIG. 3, the reviewing/managing unit 10 has a central processing unit (CPU) 10a controlling the whole system in use of a predetermined program. CPU 10a is connected to a RAM (random access memory) 10c through a bus B. RAM 10c has a storage area 20 necessary for a process of a ROM (read only memory) 10b and for a program of CPU 10a.

CPU 10a is connected to a storage unit 10d such as a hard disk through the bus B. The storage unit 10d can store various kinds of files to review and manage the working scheme for realization of the scheme. CPU 10a also connects to an input section interface (I/F) 10e, a display section interface (I/F) 10f, and a communication section interface (I/F) 10g through the bus B. The input section interface 10e connects to an input section 11 having a keyboard and a mouse. Data from the input section 11 is input through the bus B into CPU 10a.

The display interface 10f connects to a display section 12 having a liquid crystal display. The display interface 10f transmits image signals to the display section 12 through the cables 33 according to instructions of CPU 10a.

The communication interface 10g connects to a communication section 13 that is a communication unit like a LAN card. Data supplied from CPU 10a to the communication interface 10g is output to the communication section 13 through the cables 31.

Each intelligent terminal unit 20 of FIG. 2 has a capacity almost the same as that of the reviewing/managing unit 10.

As illustrated in FIG. 4, the storage unit 10d of the reviewing/managing unit 10 stores a working scheme reviewing/managing program file F1, a long-term timetable management file F2, a medium-term timetable management file F3, and a short-term timetable management file F4.

The working scheme reviewing and managing program file F1 stores programs for realization of the working scheme drawn up by a plurality of the staffs. The program file F1 is used to develop a long-term timetable (yearly schedule) of the working scheme, a medium-term timetable (monthly schedule), and a short-term timetable (weekly schedule).

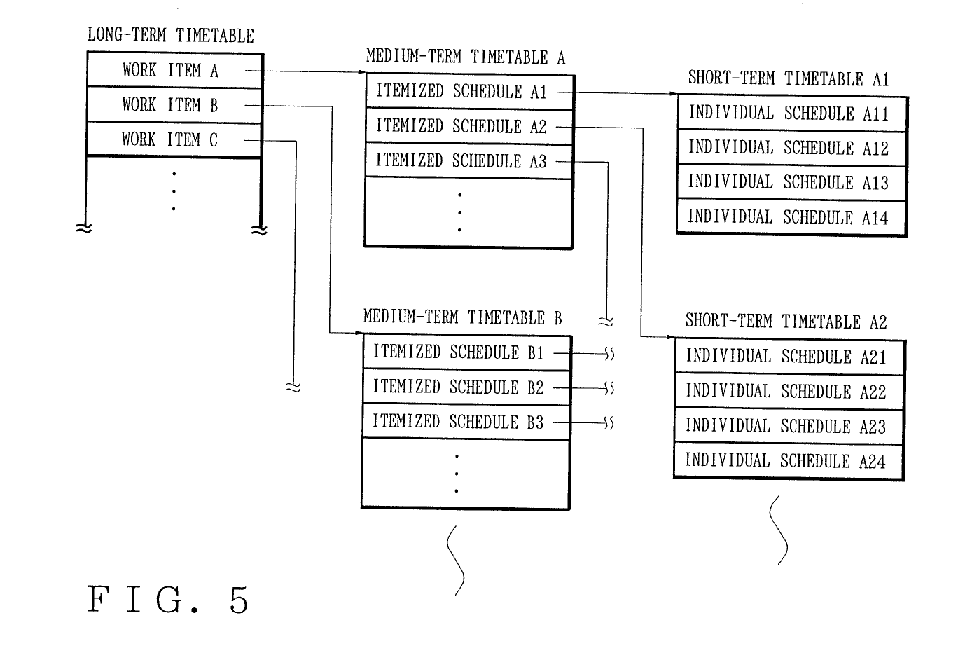

In the long-term timetable management file F2, as illustrated in FIG. 5, the long-term timetable has a plurality of work items A, B, C, . . . to realize the working scheme. The work items include the name of a staff in charge of each work item, an objective of the work, a detailed schedule of the work, and an associated actual work, etc. The medium-term timetable management file F3, as illustrated in FIG. 5, has medium-term timetables A, B, . . . associated with the work items A, B, C, . . . Each medium-term timetable has a plurality of itemized schedules A1, A2, A3, . . . , B1, B2, B3, . . . . Each itemized schedule includes the name of a staff in charge of each work, a detailed schedule of the work, and an associated actual work, etc.

The short-term timetable management file F4, as illustrated in FIG. 5, has individual schedules of staffs in charge for each itemized schedule A1, A2, . . . . Each itemized schedule includes individual schedule A11 to A14, or A21 to A24, . . . . Each individual schedule includes the name of a staff in charge of each work, a detailed schedule of the work, and an associated actual work, etc.

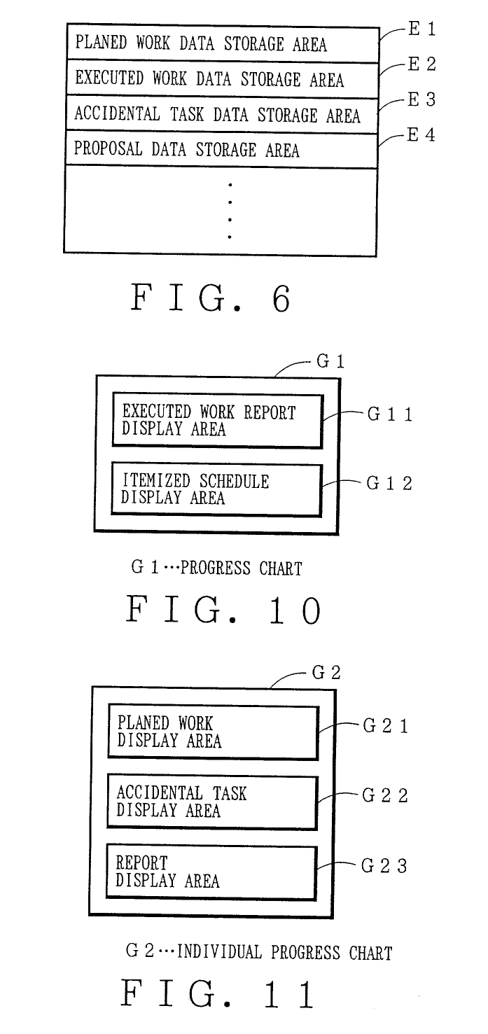

FIG. 6 shows an example of the individual schedule. The individual schedule includes a planed work data storage area E1 for storing data of a work planned by the staffs; an executed work data storage area E2 for storing data of an executed work report corresponding to a planed work; an accidental task data storage area E3 for storing data of an accidentally occurred task; a proposal data storage area E4 for storing a proposal data to show a planed work (individual schedule), which has not been executed, with a reason and a problem thereof to the staffs; and etc.

As described above, the medium-term timetable management file F3 stores the itemized schedules, and the short-term timetable management file F4 stores the individual schedules and the executed work reports. Thus, the storage unit 10d serves as an itemized schedule storage means, an individual schedule storage means, an executed work report storage means, and a report storage means.

In the embodiment, various files including the working scheme reviewing and managing program file F1 are installed into the storage unit 10d in use of storage mediums such as a CD-ROM and a floppy disk accessible for computers. However, the present invention may use another installing method of the files such as download through the communication section 13 by an internet service or telecommunication lines.

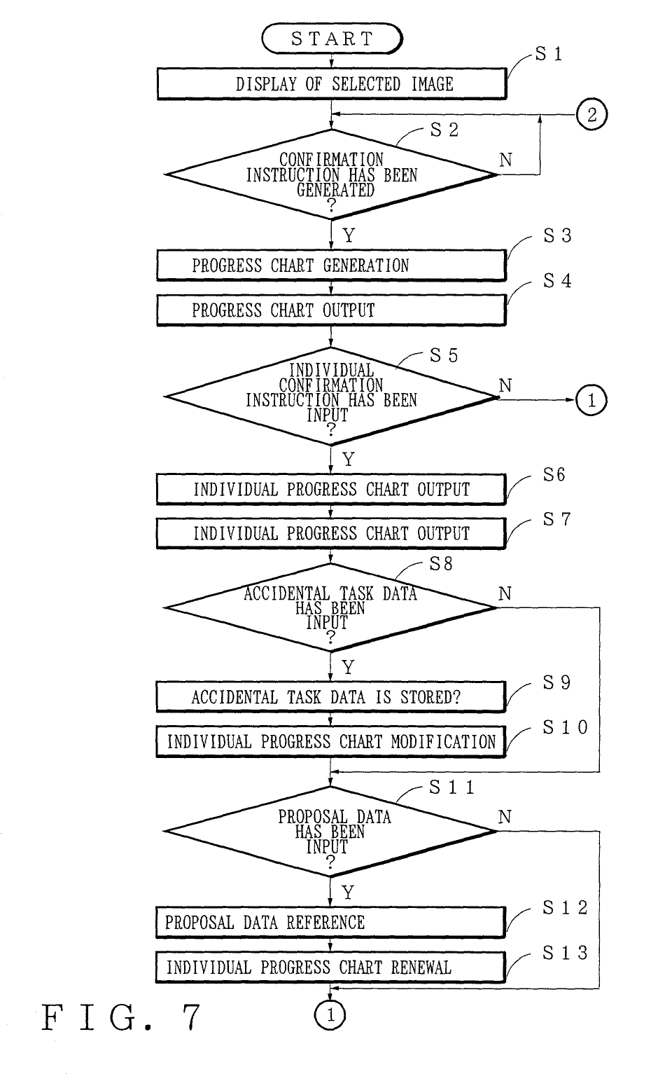

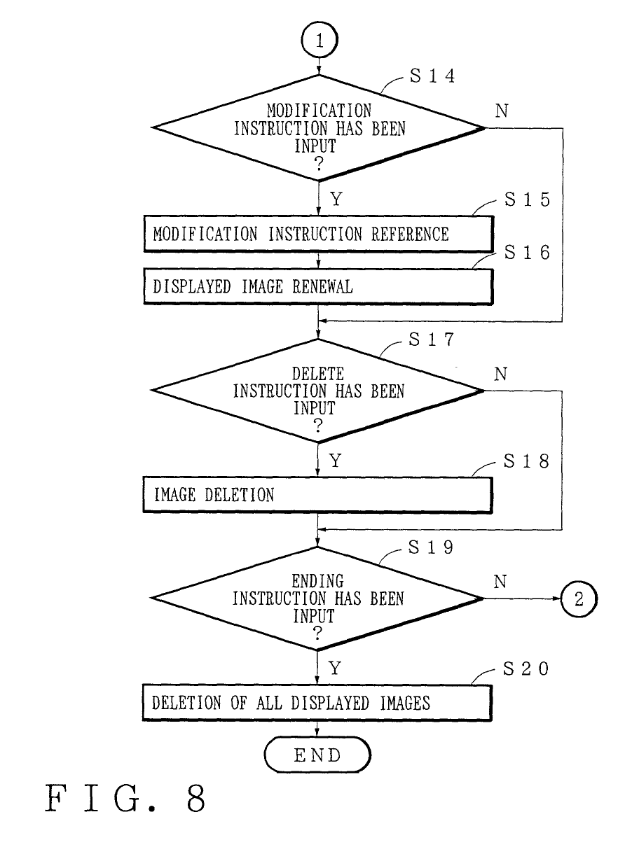

Referring to flowcharts FIGS. 7 and 8, an example of a general process executed by CPU 10a of the reviewing and managing unit 10 will be discussed. The execution utilizes the working scheme reviewing and managing program F1 stored in the storage unit 10d. In the embodiment, the projector 40 displays an image supplied from the display section 12 of the reviewing/managing unit 10, which will be specified in the following discussion.

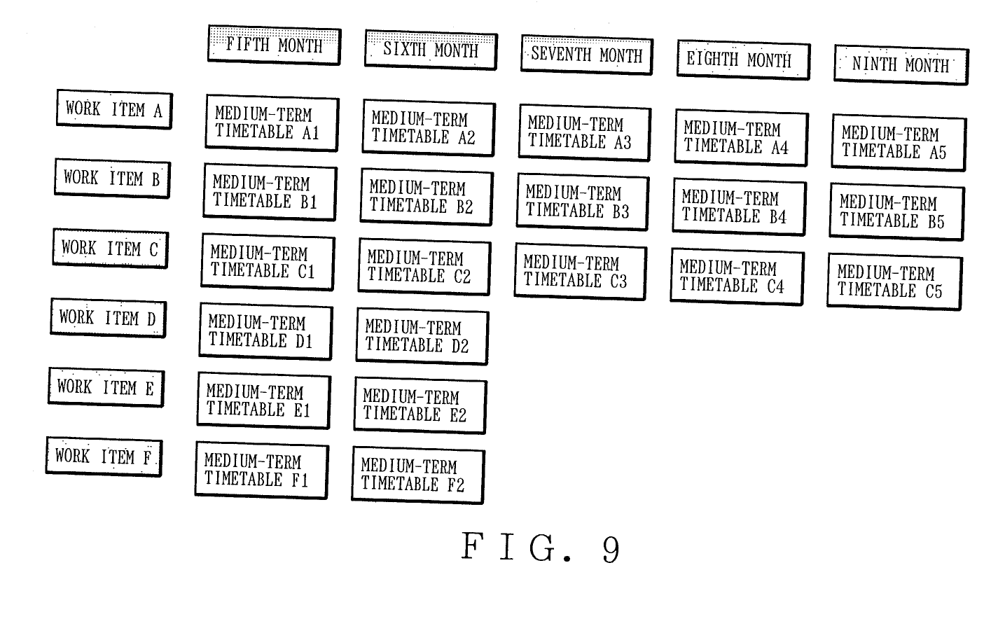

When the working scheme reviewing and managing program Fl starts, a step S1 of FIG. 7 selects one of images shown in FIG. 9, and the selected image is output to the display interface 10f to be displayed by the display section 12. From the display interface 10f, the image signals are supplied to the projector 40 through one of the cables 33 to display the selected image on the screen 41.

A matrix of the selected images shown in FIG. 9 has rows each associated with one of work items A to F and columns each associated with one of fifth to ninth months. The matrix provides a plurality of selection keys for selecting any of the medium-term timetables. When one of the keys is selected through an operation of the input section 11 by one of the staffs, a confirmation instruction for confirming a progress state of the selected medium-term timetable is usually generated before the process goes to a next step S2.

The step S2 determines whether the confirmation instruction has been generated or not by the operation the input section 11. When there is no confirmation instruction (N in the step S2), the step is repeated until a confirmation instruction is generated. On the contrary, When there is a confirmation instruction (Y in the step S2), the process goes to a step S3.

The step S3 generates a progress chart in RAM 10c to display, for example, a progress chart G1 shown in FIG. 10, and the process goes to a step S4. The step S3 corresponds to the progress chart generating means described in the invention summary.

The step S4 outputs the progress chart of RAM 10c to the display interface 10f, and then the process goes to a step S5. Like the step S1, the progress chart G1 is displayed at the display section 12 and on the screen 41.

The progress chart G1 includes an executed work report display area G11 showing an actual work corresponding to an itemized schedule and an itemized schedule display area G12 showing the itemized schedule corresponding to a medium-term timetable.

For example, when the medium-term timetable A3 is selected, there are generated an executed work report and a progress chart. The executed work report is generated based on an actual data of the medium-term timetable A1 and the medium-term timetable A2. The progress chart is generated based on an itemized schedule corresponding the medium-term timetable A3. Since the work schedule and the work result of the selected work item are displayed on the same screen, the staffs can easily recognize a progress state of the work item.

Each display area described above is configured to be able to select an individual schedule (short-term timetable) associated with one of the staffs in charge. The selection can generate an individual confirmation instruction for confirming a progress state of the staff.

The step S5 determines whether the individual confirmation instruction has been generated or not. When the individual confirmation instruction has not been generated (N in step S5), the process goes to a step S14 shown in FIG. 8. On the contrary, when the individual confirmation instruction has been generated (Y in step S5), the process goes to a step S6.

The step S6 generates an individual progress chart in RAM 10c to display, for example, an individual progress chart G2 shown in FIG. 11, and then the process goes to a step S7. The step 6 corresponds to the individual progress chart generating means described in the invention summary.

The step S7 outputs the individual progress chart of RAM 10c to the display interface 10f, and then the process goes to a step S8. Like the step S1, the individual progress chart G2 is displayed on the display section 12 and the screen 41.

The individual progress chart G2 is based on information of the primary progress chart. The individual progress chart G2 includes: a planed work display area G21 for displaying a planed work stored in the planed work data storage area El and the executed work data storage area E2 in respect of the selected individual schedule; an accidental task display area G22 for displaying an accidental task stored in the accidental task data storage area E3: and a report display area G23 for displaying a report generated based on data in the proposal data storage area E4.

The step S8 determines whether an accidental task data has been input through the input section 11 or not. When the accidental task data has not been input (N in step S8), the process goes to a step S11. On the contrary, when the accidental task data has been input (Y in step S8), the process goes to a step S9.

The step S9 recognizes the individual schedule corresponding to the displayed progress chart G2, and the accidental task data is stored in the accidental task data storage area E3. Then, the process goes to a step S10. The step S9 corresponds to the re-scheduling means described in the invention summary.

The step S10 renews the individual progress chart of RAM 10c with reference to the accidental task data. The individual progress chart is output to the display interface 10f, and then the process goes to the step S11. Like the step S1, the individual progress chart G2 modified based on the accidental task data is displayed on the display section 12 and the screen 41.

The step S11 determines whether a proposal data (report) has been input through the input section 11. The proposal data is made to modify the individual schedule based on the displayed individual progress chart G2. When the proposal data has not been input (N in step S11), the process goes to a step S14 shown in FIG. 8. On the contrary, when the proposal data has been input (Y in step S11), the process goes to a step S12.

The step S12 recognizes the individual schedule corresponding to the displayed individual progress chart G2 and receives the proposal data in the proposal data storage area E4. Then, the process goes to a step S13.

The step S13 renews the individual progress chart corresponding to the individual schedule in RAM 10c with reference to the proposal data. The individual progress chart is output to the display interface l0f, and then the process goes to the step S14 of FIG. 8. Like the step S1, the renewed individual progress chart G2 modified by the proposal data is displayed on the display section 12 and the screen 41.

The step S14 of FIG. 8 determines whether a modification instruction has been input through the input section 11. The modification instruction modifies at least one of the itemized schedule and the individual schedule with reference to the displayed progress chart G1. When the modification instruction has not been input (N in step S14), the process goes to a step S17. On the contrary, when the modification instruction has been input (Y in step S14), the process goes to a step S15.

The step S15 recognizes and modifies at least one of the itemized schedule and the individual schedule based on the modification instruction, and then the process goes to a step S16. The step S15 corresponds to the modification means described in the invention summary. The step S16 renews image information of the itemized schedule and the individual schedule in RAM 10c based on the modification instruction. The renewed image is output to the display interface 10f, and then the process goes to the step S17. Like the step S1, the renewed image is displayed on the display section 12 and the screen 41.

The step S17 determines whether a delete instruction has been input or not. When the decision is negative (N in step S17), the process goes to a step S19. On the contrary, when the decision in positive, (Y in step S17), the process goes to a step S18.

The step S18 outputs a signal to the display interface 10f for deleting an image according to the delete instruction, and then the process goes to a step S19. Thereby, the image corresponding to the delete instruction is deleted from the display section 12 and the screen 41.

The step S19 determines whether an ending instruction has been input for ending the working scheme reviewing and managing program Fl or not. When the decision is negative (N in step S19), the process returns to the step S2 of FIG. 7 to sequentially repeat the following steps. On the contrary, when the decision is positive, (Y in step S19), the process goes to a step S20.

The step S20 outputs a signal for deleting all the displayed image to the display interface 10f, and then the process is ended. Thereby, all the images on the display section 12 and the screen 4 are deleted.

As described above, the step S4 outputs the progress chart information to display the progress chart GI, and the step S7 outputs the individual progress chart information to display the individual progress chart G2. That is, the steps S4 and S7 correspond to the output means described in the invention summary.

As appreciated from the above discussions, CPU 10a of the reviewing/managing unit 10 functions as the progress chart generating means, the output means, the modification means, the individual progress chart generating means, and the re-scheduling mean which are described in the invention summary.

Next, referring again the drawings, an operation of the embodiment will be discussed.

When a progress promotion meeting of the working scheme by all the staffs is made, the chairman brings the reviewing/managing unit 10, and the other staffs bring their intelligent terminal units 20 into a meeting room. Each staff connects his intelligent terminal unit 20 to the main unit on the table 30. Thereby, the intelligent terminal units 20 can communicate with each other and the main unit through the cables 31. The unit 10 is connected to the switching unit 34 through one of the cables 33.

The chairman operates the reviewing/managing unit 10 to execute the working scheme reviewing and managing program Fl. The projector 40 displays an image of related to a selected one of the timetables of FIG. 9 on the screen 41 (step S1). For example, when the sixth medium-term timetable A2 is selected for review thereof, the progress chart G1 of FIG. 10 is displayed on the screen 41 (steps S3 to S4) The executed work report display area G11 of the progress chart G1 shows the executed work report up to the fifth month, and the itemized schedule display area G12 shows the sixth month information of the chart G1.

The staffs can recognize the progress state of the working scheme by reviewing the progress chart G1 and can know the problems interfering with the working scheme. That is, the staffs can review the working scheme with ease. All the staffs can know the problems of the working scheme by reviewing the progress chart G1, so that the problems can be analyzed to be solved by all the staffs.

According to solutions of the problems, the work items and the individual schedules are modified, and the modification instruction is provided (Y in step S14). The modifications of the work items and the individual schedules are referenced in the itemized schedules and the individual schedules, and the related displaying images are renewed (steps S15 to S16).

Thus, the present invention can solve the problems of the conventional KI plan which is disadvantageous for reviewing a primary schedule chart with referring other schedule charts. That is, based on visibly developed charts and problems, all the staffs can review and modify the working scheme, thereby realizing the working scheme well drawn up by all the staffs.

When the chairman provides the individual confirmation instruction based on the displayed chart G1 (Yin step S5), the individual progress chart G2 of a staff associated with the chart G1 is displayed on the screen 41 (steps S6 to S7). The individual progress chart G2 shows the planed work information of the staff in the planed work display area G21 and shows the accidental task information in the accidental task display area G22. Furthermore, the report display area G23 of the individual progress chart G2 shows a report of problems and reasons thereof in respect of the staff.

The individual progress chart is generated based on the individual schedule and the executed work report, so that the individual progress chart G2 includes the progress states of the work items. This allows to manage an individual progress state associated with each staff corresponding to the individual progress chart G2. Since the progress chart G1 includes the individual progress chart G2, the progress state of each item can be reviewed while the progress states of the individual schedules are reviewed.

The accidental task is displayed in the accidental task display area G22 of the individual progress chart G2. Thus, with reference of the accidental task, the progress management and the adjustment of the working scheme can be done by all the staffs. This allows a reliable review of the working scheme to maintain and realize the scheme.

The individual progress chart G2 includes the report display area G23, so that the report presents the problems of some of the staffs to all of them. This allows quick solutions of the problems.

The individual schedule corresponding to the displayed progress chart G2 is recognized and the accidental task data is stored in the accidental task data storage area E3 (step S9). The individual progress chart G2 is renewed with reference to the accidental task data to be displayed again (step S10).

The step S12 recognizes the individual schedule corresponding to the displayed individual progress chart G2 and receives the proposal data in the proposal data storage area E4. Thus, the individual progress chart G2 corresponding to the individual schedule is renewed with reference to of the proposal data to be displayed again (step S13).

In the embodiment, the accidental task data and the proposal data are input by the input section 11 of the reviewing/managing unit 10. However, according to the present invention, the staffs can input the data to the reviewing/managing unit 10 by one of the intelligent terminal units 20 through the cable 31 and the communication section 13. Thereby, any of the staffs can modify the itemized schedule and the individual schedule.

As described above, the projector 40 displays the progress chart G1, the individual progress chart G2, etc. which are output by the reviewing/managing unit 10. The displayed charts are simultaneously visible for a plurality of the staffs. The staffs can analyze the working scheme and the problems interfering with the scheme with referring to the progress chart G1, the individual progress chart G2, etc. Thus, the working scheme can be reviewed by the plurality of the staffs to maintain and realize the scheme.

In the embodiment, the progress chart G1, the individual progress chart G2, etc. are displayed by the projector (display unit) 40. However, in the present invention, the charts may be displayed in the intelligent terminal unit 20 of each of the staffs.

In the configuration of FIG. 2, an interactive communication may be enabled between the reviewing/managing unit 10 and the intelligent terminal units 20 through the cable 31. The reviewing/managing unit 10 provides the progress chart, the individual progress chart, etc. to the intelligent terminal units 20. The intelligent terminal unit 20 displays the progress chart G1, the individual progress chart G2, etc. to the staffs.

The display potion of the intelligent terminal unit 20 of each staff can display the progress chart G1, the individual progress chart G2, etc. which are output by the reviewing/managing unit 10. Even when the staffs can not gather in a meeting room, the staffs can analyze the working scheme and the problems interfering with the scheme with referring to the progress chart G1, the individual progress chart G2, etc. Thus, the working scheme reviewing/managing system has the reviewing/managing unit 10 as a server and each intelligent terminal units 20 as a client.

Accordingly, all the staffs can review the working scheme to maintain and realize the scheme. In addition, a large amount of paper copies otherwise needed could be eliminated for the reviewing of working scheme.

What is claimed is:

1. A working scheme reviewing and managing unit that can display problems interfering with a working scheme to a plurality of staffs to realize the working scheme, the working scheme drawn up by the staffs, the system comprising:
an itemized schedule storage means for storing schedules each associated with each of a plurality of work items to realize the working scheme,
an individual schedule storage means for storing an individual schedule associated with each of the staffs in connection with the itemized schedules,
an executed work report storage means for storing executed work reports each in connection with each of the individual schedules,
a progress chart generating means for displaying a progress chart of the working scheme based on the itemized schedules and the executed work reports,
an output means for outputting the progress chart generated by the progress chart generating means to display the progress chart according to a confirmation instruction for confirming a progress state of the working scheme, and
a modification means for modifying at least one of the itemized schedules and the individual schedules according to a modification instruction based on the displayed progress chart.

2. The unit as claimed in claim 1, wherein the unit further comprises an individual progress chart generating means for generating an individual progress chart based on the individual schedules and the executed work reports according to an individual confirmation instruction for confirming an individual progress state of the work items, and the output means outputs the individual progress chart to display the individual progress chart.

3. The unit as claimed in claim 2, wherein the unit further comprises a report storage means for storing a report in connection with one of the individual schedules which can not be executed as planed so as to provide the report to the staffs with regard to reasons and problems of the individual schedule, and the individual progress chart generating means generates the individual progress chart as a chart including a display area for displaying the report associated with the individual schedule.

4. The unit as claimed in claim 2, wherein the individual schedule comprises an accidental task data associated with a task not preliminarily included in the work schedule, and the unit further comprises a re-scheduling means that modifies the individual schedule according to the accidental task data, wherein the individual progress chart generating means generates the individual progress chart as a chart having an accidental task display area for displaying the accidental task data of the individual schedule.

5. A working scheme reviewing and managing system having the reviewing and managing unit as claimed in claim 1, the system comprising a display unit that can be seen simultaneously by all the staffs so that the staffs can review the working scheme based on information indicated on the display unit, wherein the indicated information is based on an output from the output means of the reviewing and managing unit.

6. A working scheme reviewing and managing system having the reviewing and managing unit as claimed in claim 1, the system comprising a plurality of intelligent terminal units each provided for each of the staffs, the intelligent terminal units connected to the reviewing and managing unit through a network, wherein each of the intelligent terminal units can display information based on an output from the output means of the reviewing and managing unit.

7. The system as claimed in claim 5, the system comprises a plurality of intelligent terminal units each provided for each of the staffs, the intelligent terminal units connected to the reviewing and managing unit through a network, wherein each of the intelligent terminal units can display information based on an output from the output means of the reviewing and managing unit.

8. The system as claimed in claim 7, the intelligent terminal unit and the reviewing and managing unit have respectively an input means, wherein the intelligent terminal unit and the reviewing and managing unit can transmit information to each other.

9. The system as claimed in claim 8, the intelligent terminal unit and the reviewing and managing unit are portable and are connected to the network with quick coupling-type connectors.
